(19) United States
(12) Patent Application Publication
(10) Pub. No.: US 2025/0133262 A1
(43) Pub. Date: Apr. 24, 2025

(54) Automated Media Packaging, Validation and Delivery System

(71) Applicant: Paulette Pantoja, Santa Clarita, CA (US)

(72) Inventor: Paulette Pantoja, Santa Clarita, CA (US)

(21) Appl. No.: 19/005,214

(22) Filed: Dec. 30, 2024

Related U.S. Application Data
(63) Continuation-in-part of application No. 18/680,503, filed on May 31, 2024.
(60) Provisional application No. 63/505,702, filed on Jun. 1, 2023.

(51) Int. Cl. H04N 21/44; H04N 21/439; H04N 21/466; H04N 21/81

(52) U.S. Cl. CPC H04N 21/44008; H04N 21/4394; H04N 21/466; H04N 21/812

(57) ABSTRACT

A scalable, automated media detection and validation system that integrates AI-driven technologies for detecting various elements within video/audio content, such as ad break points, adult language, nudity, and graphics. The system automatically ingests media content and applies AI models to detect instances, which are then filtered and validated using rule-based profiles. The results are displayed in a user interface that allows users to review, toggle between profiles, and select time codes based on predefined rules. The system provides a flexible, automated workflow with scalability for high-volume content, allowing the final results to be exported in multiple formats such as JSON or through downloads.

### RELATED APPLICATIONS

This application is a continuation in part of pending U.S. patent application Ser. No. 18/680,503, filed May 31, 2024, which claims priority to U.S. Provisional Patent Application No. 63/505,702, filed Jun. 1, 2023.

### FIELD OF THE INVENTION

The present disclosure relates generally to a system and method for detection and validation of points in video media, such as points in video content for advertisement placement, adult language, nudity and graphics through the use of artificial intelligence (AI) technologies. Specifically, the disclosure integrates AI models into a graphical user interface (GUI) that allows users to apply saved profiles or rules to filter the detected instances. The system is scalable and automates both the ingestion of content and the application of AI for high-volume media processing. The disclosure also teaches a system and method which automatically ingests media content and applies AI models to detect instances, which are then filtered and validated using rule-based profiles which enable the automated modification of content through, for instance, automated placement of ad content. The results are displayed in a user interface that allows users to review, toggle between profiles, and select time codes based on predefined rules. The system provides a flexible, automated workflow with scalability for high-volume content, allowing the final results to be exported in multiple formats such as JSON or through downloads.

### BACKGROUND OF THE INVENTION

In the days of the over-the-air broadcasts on a limited number of television channels, video content was tailored to fit a standard time slot (e.g., a 30-minute show) with standard breakpoints in the content for the display of advertisements. Moreover, due to content standards, monitoring of nudity, language or other content was not an issue. A major source of revenue for commercial television broadcasters is the sale of broadcast time to advertisers. Advertising is the main source of income for national television broadcasters and their local over-the-air affiliates. In addition, the public nature of the broadcasts limited the ability of some objectionable content according to the regulations of FCC or other similar rules.

With the development of alternative streaming channels (e.g., online video channels such as YouTube and others), the standardization of content format has lessened or ceased. Moreover, such venues are not subject to the same kind of content regulation as over-the-air channels. Perhaps most important, the lack of any standardization of content has in turn led to a lack of standardization for the placement or timing of advertisements.

Some related problems exist relative to the advertising and utility of such content, too. Namely, having such new content formatting creates a need for easier ways to access chapter points, credit sequence or other miscellaneous markers for playback. Likewise, certain content forms (e.g., sporting events, award shows, etc.) would benefit from the ability to select certain content (e.g., key moments or “hero shots”) to jump to or use in highlights.

The need for automated media analysis has grown with the expansion of digital content across multiple platforms. Currently, content detection systems, especially those that analyze video and audio for ad breaks, compliance issues, or specific events, often rely on manual processes or basic automation. These systems lack the flexibility to handle large-scale, high-volume media, as well as the ability to cross-reference detected elements with predefined rule sets.

In many cases, manual validation of time codes and detected events is time-consuming, and existing solutions fail to provide adequate user interfaces for applying custom rules to these results. For example, detecting ad break points based solely on black frames or scene changes without further filtering results in unnecessary manual labor to meet platform-specific guidelines. There is a need for a comprehensive system that integrates AI for detection, automates validation based on saved rules, and presents the results in an intuitive user interface for further review.

### SUMMARY AND OBJECTS OF THE INVENTION

The present disclosure provides an automated system that uses AI-driven technologies to detect various elements in media content, such ad breaks, compliance violations and other key events.

After content is ingested or loaded, the system applies AI models to automatically detect instances such as black frames, silence, adult language, nudity, and graphics. These detect events or content elements are filtered and validtate through rule-based profiles saved in the system.

The present system presents the results in a GUI, thus allowing user to toggles between profiles or rules to further refine the results and select time codes. Such time codes can then be exported via JSON or downloaded for further use or distribution. The system also creates a review file, matching the source file, for user reference during the validation process. This workflow is scalable for handling high volumes of media, offering flexibility for various applications such as ad break detection, contention moderation, and compliance.

It is an object of embodiments of the present invention to provide a system that allows for Full cloud-based application. An intuitive, automated detection and selection tool to streamline the process of choosing frame accurate points/markers for any type of audio and visual event.

Another object of the present invention is to provide a system and method for finding frame accurate event breaks to insert advertising, including the use of automated rules to implement such a process.

Still another object of the present invention is to provide a system and method to enable markers, including chapter points, credits in/out and other similar markers for playback.

Yet another object of the present invention is to provide a system and method to enable content moderation through the quick finding of specific event types (e.g., violence, adult content, etc.).

A further object of the present invention is to provide a system and method to enable the quick and effective selection of highlights (e.g., key moments and/or “hero shots”) from content such as sporting events, awards shows and the like.

The system of the present invention typically includes one or more client computers which generates or accepts profiles from a server via cloud-based application to operate upon data from the review of video content by a commercially available artificial intelligence (“AI”) engine to enable the creation of automated cue points, as well as cue point review and validation, and other advanced control features. The system can then provide the resulting output in a variety of output formats (e.g., timecode, meditime, frames or the like) for subsequent use by the client or viewer.

Other features and advantages of the present invention will be apparent from the accompanying drawings and from the detailed description that follows.

### BRIEF DESCRIPTION OF THE DRAWINGS

The present invention is illustrated by way of example and not limitation in the figures of the accompanying drawings in which like references indicate similar elements, and in which:

FIG. 1 illustrates a computer network that includes client computers coupled to a server computer, and that is used to implement embodiments of the present invention;

FIG. 2 is an example graphic user interface for a client or operator accessing the computer network that implements embodiments of the present invention;

### DESCRIPTION OF THE PREFERRED EMBODIMENTS

In the following description, for purposes of explanation, numerous specific details are set forth in order to provide an understanding of the present invention. It will be evident, however, to one skilled in the art that the present invention may be practiced without certain specific details. In other instances, well-known structures and devices are shown in block diagram form to facilitate explanation. The description of preferred embodiments is not intended to limit the scope of the claims appended hereto. In addition, future and present alternatives and modifications to the preferred embodiments described below are contemplated. Any alternatives or modifications which make insubstantial changes in function, in purpose, in structure, or in result are intended to be covered by the claims of this patent.

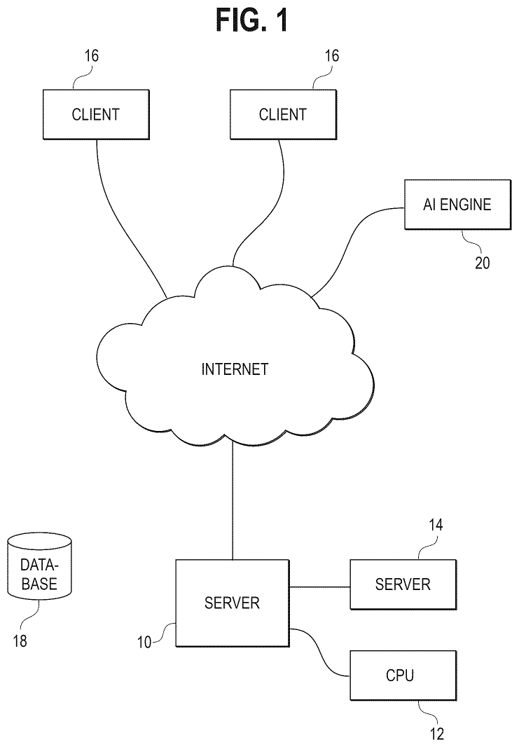

As shown in FIG. 1, the system embodiments of the present invention may be implemented on one or more computers comprising a computer network. According to one embodiment of the present invention, a server computer 10 transmits and receives data over a computer network. The steps of accessing, downloading or uploading, and manipulating the data, as well as other aspects of the present invention are implemented by a central processing unit (CPU) 12 in the server computer 10 executing sequences of instructions stored in a server memory 14. The server memory may be a random access memory (RAM), read-only memory (ROM), a persistent store, such as a mass storage device, a separate storage device, a cloud drive, or any combination of these devices. Execution of the sequences of instructions causes the CPU to perform steps according to embodiments of the present invention.

Information may be uploaded or input into to the server computer 10 from one or more other computer systems over a network connection. For example, a client computer 16 may transmit data to the server computer in order to enable cue point detection and validation. Once the server computer has ingested the content data or information and stores it in memory 14, the artificial intelligence (“AI”) engine 20 uses AI models designed to detect various elements, including: a) ad break points, wherein the AI identifies moments of black frames, silence and scene changes in the video and audio streams; b) compliance issues, where the AI models detects potential content issues, such as adult language, nudity or inappropriate graphics; c) other elements programmed to be detected based upon the use case.

The server computer 10 may also store the information for updating a database 18, and it may automatically output (or direct the output) of video content or related information to one or more client computers 16 depending upon the nature of the information the server computer 10 receives. In some cases, the event information may be executed by the CPU, and may also be executed by the CPU in conjunction with a rule set (not shown) that interprets the input and forwards certain information to display on a given client computer depending upon the rule sets or profiles selected by various client computers and/or the selection by various clients to receive such automatic notification. Thus, the present invention is not limited to any specific combination of hardware circuitry and software, nor to any particular source code for the instructions executed by the server or client computers.

Information may be uploaded or input into to the server computer 10 from one or more other computer systems over a network connection. For example, a client computer 16 or an AI engine 20 may transmit data to the server computer in response to video being analyzed for detecting objects or scenes in audio-video content provided to it. The system begins by automatically ingesting media content through an API, watch folder, or similar automated retrieval mechanism. The system can handle high-volume content ingestion without manual intervention, making it suitable for large-scale media processing. As server 10 receives the upload or input over the network/internet connection, it can also store the information in memory. The server 10 may store the information for updating a database 18 in memory 14, and it may automatically output analysis to one or more client computers 16 depending upon the nature of the information the server computer 10 receives. In some cases, the event information may not be directly executable by the CPU 12, and may instead be executed by a rule set that interprets the input and forwards information to select client computers 16 depending upon the rule sets or profiles employed by various client computers. In such an embodiment, after AI detection, the server computer 10 applies saved profiles or rules 22 to filter the results. For example, an example “ad break” rule could provide that no ad break should occur within a) the first 5 minutes; b) no sooner than every 7 minutes after the prior ad break; and/or c) not within the last 5 minutes of the video. The time codes of detected instances are recalibrated based on these rules, ensuring that the final, filtered results comply with the predefined guidelines.

In other embodiments, hardwired circuitry may be used in place of, or in combination with, software instructions to implement the present invention. Thus, the present invention is not limited to any specific combination of hardware circuitry and software, nor to any particular source code for the instructions executed by the server or client computers.

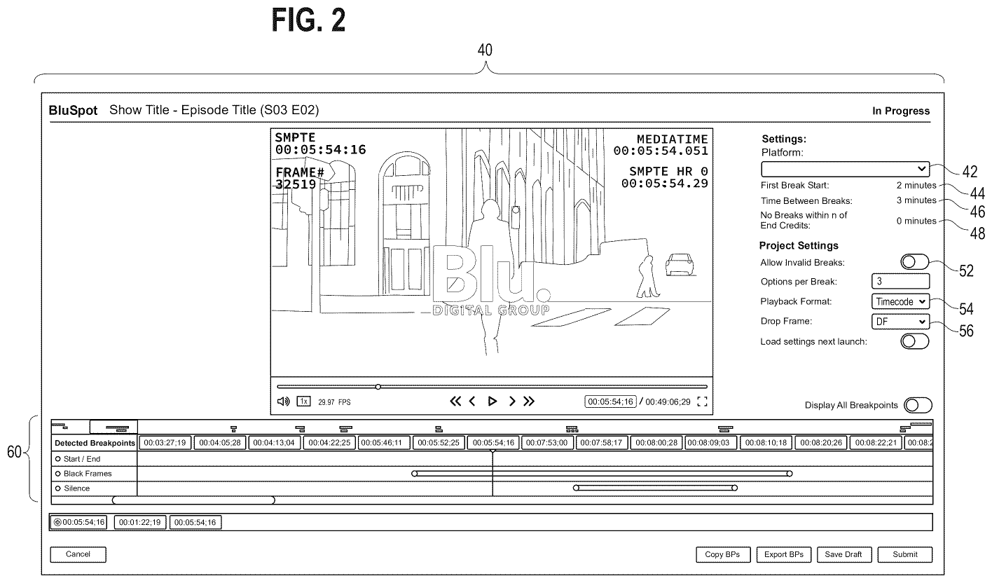

The filtered results are presented in a user interface (GUI), allowing users to: a) review the detected elements; b) toggle between different profiles or rules to refine the time codes; and/or c) use an HLS proxy file stream that matches the source file to review the content in real-time. This interface provides a seamless user experience (UX) for validating and modifying detected instances. FIG. 2 shows such a graphic user interface for various client computers. Prior to accessing this GUI, the client would be expected to provide an identification and password to a login screen (not shown) to maintain the security of the computer network. Once the password and login have been validated by the server computer, the server enables a client GUI 40 to be displayed to a client computer 16. The client GUI 40 includes a series of input points/pulldown menus for settings which allow the automatic detection and selection tool which allow the automated process of choosing frame accurate markers for any type of audio and visual event based upon a number of criteria, such as platform 42, first break start 44, time between breaks 46, and a limit on proximity of breaks to end credits 48. In this way, the system uses pre-defined (or custom) specifications to exclude unwanted detected cue points and validate user selections for accuracy. Such general settings can be controlled by the operator at client computer 16 by creating unique profiles based upon platform requirements and/or client preference, or the operator can simply employ predetermined profiles/rule sets maintained in memory 14 (which may also be stored on the client computer 16).

In addition, the client GUI 40 can include project settings for a given video content being processed, including an option to allow “invalid” breaks 52 (e.g., breaks which might otherwise violate rule sets for the timing or location of breaks), playback format 54 and drop frame/non-drop frame selection 56. Thus, the system provides users the alternative to have full creative control to manually override the system's selections. These features also allow users to mark additional supporting cue points such as intro credits, end credits, or custom-defined values.

Furthermore, the client GUI 40 include one or more bars 60 identifying detected breakpoints, including a graphical representation of detected breakpoints/cue points, such as identification of specifically detected start/end points, black frames and/or silence detected in the video being operated upon. Those of ordinary skill in the art having the teaching of the present invention and an understanding of html or similar programming will understand how to enable the pull-down menus and input boxes of the client GUI 40. In response to such detected breakpoints/cue points, the profile/rule set will automatically select cue points, e.g., breakpoints for insertions of advertisements or announcements based upon detected levels of video “black,” silence and/or scene changes. The comparison of such cue points against the rules or profile of the user as stored in memory 14 will thus cause the exclusion of cue points which do not comport with the rules stored in memory, e.g., a cue point identified in the first minute of a video may not be validated if it the user profile/rule set specified that the first break start point must be at least two minutes into the video. In such an event, the cue points thus identified would be excluded from the final processed video.

As a separate but complementary feature, the AI engine (such as the Rekognition AI engine provided by Amazon) can further enhance the capability of the rule set by performing detection capabilities of the video content e.g, adult content, violence, drugs, alcohol, etc.) for performing content moderation.

Still another separate feature of the system enables advanced controls for playback of the video being processed. Namely, the system includes NLE (non-linear editing) playback controls, as well as framerate control for any common framerate, clickable timecodes shuttle the player to the correct review point (such as the user clicking upon one or more of the bars 60) and playback speed control (with audio scrubbing).

Once the user has reviewed and selected the appropriate time codes, the system allows the results to be exported in multiple formats, such as JSON, or through direct download. These results can be sent to external systems for further processing or application. For instance, once the cue points/break points have been identified, the processor 12 can thus provide the video output containing the verified cue points with a timecode, frame number, and/or watermark burn-in (or custom burn-in). The system also enable exporting timecode values in multiple formats, including timecode (HH:MM:SS:FF), media yime (HH:MM:SS.mmm), milliseconds, seconds, seconds.milliseconds, and frames. Once the video is has such validated cue points and is stamped, the user can then transfer or send the now processed video to user computer 16 or some other, second memory containing device (not shown) for subsequent review and processing, as may be needed.

In the foregoing, a system has been described for automated cue point detection, advanced control features, and efficient marker selection capabilities make it a valuable tool for streamlining the audio and visual event selection process. The present invention has been described with reference to leveraging advanced commercially available AI engines such as Amazon's Rekognition provides accurate and reliable results for cue point/break points, improving efficiency and productivity for businesses and individuals involved in audio and video production. However, it will be evident that various modifications and changes may be made to these embodiments without departing from the broader spirit and scope of the invention as set forth in the claims. Accordingly, the specification and drawings are to be regarded in an illustrative rather than a restrictive sense.

What is claimed is:

1. A system for editing a piece of audio video content to provide a plurality of cue points based upon a rule set, said system comprising:
a) memory, the memory including a rule set for verifying cue points;
b) a server connected to the memory, the server capable of receiving inputs from a plurality of remote third party client computers;
c) an artificial intelligence engine for analyzing the piece of video content so as to identify events within the audiovideo piece content that include at least one content break from the group consisting of video black, silence, and scene changes;
d) a CPU for generating cue points within the audiovideo piece content based upon the events identified by the artificial intelligence engine, and further verifying the validity of such cue points by comparing their location within the piece of audio video content with the rule set, excluding the cue points which violate the rule set, and marking the audiovideo piece with a timecode or frame numbers so as enable the identification of the valid cue points; and
e) a second memory for storing the audiovideo piece with the verified cue points.

2. A method for automating media content detection and validation, comprising:
a) automatically ingesting media content into a storage system;
b) applying AI models to detect audiovideo content selected from the group consisting of ad breaks, adult language, nudity, and graphics;
c) filtering the detected audiovideo content using saved rules or profiles;
d) presenting the results in a graphical user interface (GUI) for review, so as to allow users to toggle between rules or profiles to further refine the results;
e) recalibrating time codes based on user-selected rules and generating a review file that matches the source file; and
f) exporting the final results through formats such as JSON or direct download.

3. The method of claim 2 wherein the AI models are applied to detect ad break points based on black frames, silence, and scene changes in the video content.

4. The method of claim 2 wherein the system allows the user to review and modify the results using an HLS proxy file stream in real-time.

5. The method of claim 2 further comprising the ability to export the final results in formats including JSON, direct download, or external system integration.

6. The method of claim 3 wherein the saved profiles or rules can be toggled within the user interface, thus providing flexibility for multiple applications beyond ad break detection.
